(19) United States
(12) Patent Application Publication
(10) Pub. No.: US 2021/0275974 A1
(43) Pub. Date: Sep. 9, 2021

(54) REVERSE OSMOSIS MEMBRANE AND MANUFACTURING METHOD THEREFOR

(71) Applicant: SK INNOVATION CO., LTD., Seoul (KR)

(72) Inventors: Min Sang PARK, Daejeon (KR); Sang Hyun PARK, Daejeon (KR)

(21) Appl. No.: 16/332,622

(22) PCT Filed: Sep. 11, 2017
(86) PCT No.: PCT/KR2017/009940

§ 371 Date: Mar. 12, 2019

(30) Foreign Application Priority Data
Sep. 12, 2016 (KR) 10-2016-0117297

(51) Int. Cl. B01D 67/00; B01D 61/02; C02F 1/44; B01D 71/56; B01D 71/26; B01D 69/12; B01D 69/06; B01D 69/02

(52) U.S. Cl. CPC B01D 67/0006; B01D 61/025; C02F 1/441; B01D 71/56; B01D 71/26; B01D 2325/24; B01D 69/06; B01D 69/02; B01D 2325/02; B01D 2325/04; B01D 69/12

(57) ABSTRACT

The present invention relates to a reverse osmosis membrane using a polyolefin-based microporous membrane and a production method therefor. The present invention relates to a method for forming a polyamide layer by interfacial polymerization on a polyolefin-based microporous membrane without separate hydrophilization treatment, wherein reaction solutions are fed in a specified order upon the interfacial polymerization to effectively form the polyamide layer on a polyolefin-based microporous membrane having hydrophobicity.

### TECHNICAL FIELD

The present invention relates to a reverse osmosis membrane using a polyolefin-based microporous membrane and a production method therefor.

The present invention relates to a method for forming a polyamide layer by interfacial polymerization on a polyolefin-based microporous membrane without separate hydrophilization treatment, wherein reaction solutions are fed in a specified order upon the interfacial polymerization to effectively form the polyamide layer on the polyolefin-based microporous membrane having hydrophobicity.

### BACKGROUND ART

An osmotic phenomenon is a natural phenomenon in which a solvent in a low concentration solution moves to a high concentration solution through a semipermeable membrane, and the move is generated by a chemical potential difference between solvents on both sides of the membrane. When chemical potentials of both sides of the membrane are equal to each other, movement of the solvent is stopped and an osmotic pressure difference as much as a head difference is generated. In this case, when a pressure with the osmotic pressure difference or more is applied to the high concentration solution side, a solvent on the high concentration solution side flows backward to the low concentration solution side as opposed to the osmosis phenomenon, which is called a reverse osmosis phenomenon. By using the reverse osmosis principle, it is possible to separate various salts and organic materials through a semipermeable membrane using a pressure gradient as a driving force. Since the reverse osmosis separation membrane using the reverse osmosis phenomenon does not employ a separation operation according to a molecular size, deposition of organic materials caused by microfiltration or ultrafiltration is less, and as a result, the membrane has an advantage of an extended lifetime and is used to supply water for household, architectural, and industrial water by separating molecular-level materials and removing salts from brine or seawater.

One of the general types of the reverse osmosis membrane is a polyamide-based separator made of a porous support and a polyamide thin film formed on the porous support. Specifically, the polyamide-based separator is produced by forming a polysulfone layer on a nonwoven fabric to form a microporous support, and forming a polyamide active layer by interfacial polymerization of a polyfunctional amine and a polyfunctional acyl halide on the microporous support. According to the production method, since a non-polar solution and a polar solution are in contact with each other, polymerization is generated only at an interface thereof, and thus a polyamide active layer having a very thin thickness is formed.

In general, in order to form the polyamide active layer, the interfacial polymerization is performed by immersing the porous support in a polyfunctional amine aqueous solution, then removing an excessive amount of the polyfunctional amine aqueous solution, and subsequently immersing the porous support in a polyfunctional acyl halide organic solution.

The reverse osmosis membrane including the polyamide-based thin film as an active layer is extremely limited in application since the reverse osmosis membrane has high stability with respect to a pH change and is capable of being operated at a low pressure, has a high salt rejection of 90% or more, but the reverse osmosis membrane has a relatively very low permeation performance.

Therefore, in order to increase the application range and economical efficiency, it is required to develop technology for improving the permeation performance of the reverse osmosis membrane so as to allow an excessive amount of water to pass through the reverse osmosis membrane while having a removal rate within an appropriate range satisfying that a salt rejection of the reverse osmosis membrane is about 40 to 90%.

However, since the conventional reverse osmosis membrane using nonwoven fabric includes a support having a thick thickness of 100 to 200 μm, there is a limitation in providing a wide processing area per unit volume, and thus there is a limitation in improving the permeation performance.

In addition, since a surface of the nonwoven fabric layer is uneven due to short fibers protruding from the surface, smoothness is not remarkably good, and it is difficult to perform uniform application even if a polymer solution such as polysulfone, or the like, is applied. Further, the polymer layer may be finely separated from the nonwoven fabric layer due to the short fibers protruding from the surface of the nonwoven fabric or durability of the reverse osmosis membrane may be significantly lowered, which may cause cracks and the like.

Further, an additional step of forming a polysulfone layer on the nonwoven fabric is required, and at the time of coating the polysulfone layer, an organic solvent having a high boiling point, such as dimethylformamide, is used, and thus a drying time is long and productivity is low.

In addition, in order for the reverse osmosis membrane to be widely used for seawater other than general brine, chemical resistance should be excellent. However, the polysulfone layer is insufficient in chemical resistance, and thus the conventional reverse osmosis membrane has a problem of not having sufficient chemical resistance to be used for separation of seawater and organic solution.

### DISCLOSURE

### Technical Problem

An object of the present invention is to provide a reverse osmosis membrane having improved water treatment performance by replacing a conventional nonwoven fabric with a microporous membrane of a thin film in the form of a film or a sheet so as to provide a wide processing area per unit volume.

Further, another object of the present invention is to provide a reverse osmosis membrane having excellent surface smoothness, excellent durability, and excellent chemical resistance and mechanical properties as compared with a conventional reverse osmosis membrane made of nonwoven fabric.

Further, still another object of the present invention is to provide a reverse osmosis membrane capable of easily obtaining commercial availability due to cheap production costs as compared to conventional nonwoven fabric.

### Technical Solution

In order to achieve the above-described object, the present invention is characterized by using a polyolefin-based microporous membrane as a substrate. However, when a polyolefin-based resin is used to produce a microporous membrane, since the polyolefin-based resin is hydrophobic, it is required to perform a hydrophilization treatment of modifying a surface of the polyolefin-based microporous membrane to have hydrophilicity in order to impregnate a polyfunctional amine aqueous solution into the microporous membrane. In order to hydrophilize the polyolefin-based microporous membrane, any one selected from a surfactant, a surface active agent, a wetting agent, a polymer solution including inorganic particles, and a hydrophilic polymer may be coated to form a coating layer, or any one method of grafting the polyolefin-based microporous membrane with a hydrophilic polymer by plasma treatment, UV-ozone treatment, corona discharge, surface foaming, or plasma treatment may be used. However, there is a problem in that physical properties of the polyolefin-based microporous membrane may be deformed during the hydrophilization treatment process.

Therefore, the present invention is characterized by specifying the feeding order of solutions at the time of interfacial polymerization to form a polyamide active layer even without a separate hydrophilization treatment of the polyolefin-based microporous membrane.

More specifically, in one general aspect, a production method for a reverse osmosis membrane includes: contacting a polyolefin-based microporous membrane with a polyfunctional acyl halide organic solution, and then contacting the polyolefin-based microporous membrane with a polyfunctional amine aqueous solution to form a polyamide active layer.

The polyolefin-based microporous membrane may have a water contact angle of more than 90 degrees.

The contacting may be coating or immersion.

The polyolefin-based microporous membrane may have a porosity of 20 to 70%, a maximum pore size measured by a bubble point method of 0.1 μm or less, and a multiplication of tensile strength and thickness in at least one of a transverse direction and a longitudinal direction is 0.3 kgf/cm or more.

The polyolefin-based microporous membrane may be a film or a sheet.

The polyolefin-based microporous membrane may be selected from:

a single-layered microporous membrane made of any one selected from polyethylene, polypropylene, and a mixture thereof; a composite microporous membrane having two or more layers in which polyethylene and polypropylene are alternately stacked; and

a multilayer microporous membrane in which two or more layers of polyethylene or polypropylene are stacked.

The polyfunctional acyl halide organic solution may be obtained by dissolving a polyfunctional acyl halide compound in an aliphatic hydrocarbon-based organic solution, and the polyfunctional amine aqueous solution may be obtained by dissolving a polyfunctional amine in water.

In another general aspect, a reverse osmosis membrane includes: a polyamide active layer formed on a polyolefin-based microporous membrane, wherein the polyolefin-based microporous membrane has a water contact angle of more than 90 degrees.

The polyolefin-based microporous membrane may have a porosity of 20 to 70%, a maximum pore size measured by a bubble point method of 0.1 μm or less, and a multiplication of tensile strength and thickness in at least one of a transverse direction and a longitudinal direction is 0.3 kgf/cm or more.

The polyolefin-based microporous membrane may be selected from:

a single-layered microporous membrane made of any one selected from polyethylene, polypropylene, and a mixture thereof;

a composite microporous membrane having two or more layers in which polyethylene and polypropylene are alternately stacked; and

a multilayer microporous membrane in which two or more layers of polyethylene or polypropylene are stacked.

### Advantageous Effects

The reverse osmosis membrane of the present invention provides a wide treatment area per unit volume by using a support in the form of a film having a thin thickness, thereby having an increased permeate flow rate, and an excellent salt rejection to improve water treatment performance.

Further, by using the polyolefin-based microporous membrane, it is possible to provide excellent surface smoothness, excellent durability, and excellent chemical resistance and mechanical properties.

In addition, since the polyamide active layer is formed without performing the separate hydrophilization treatment process on the polyolefin-based microporous membrane, the production process is simplified and the production thereof is easy.

### BEST MODE

Hereinafter, a reverse osmosis membrane according to the present invention and a production method therefor are described in detail with reference to specific embodiments. It should be understood, however, that the following specific exemplary embodiments or Examples are only illustrative of the present invention in detail, and the present invention is not limited thereto, and may be implemented in various forms.

In addition, unless defined otherwise, all technical and scientific terms used herein have the same meanings as commonly understood by one of those skilled in the art to which the present invention pertains. Terms used herein are provided for the purpose of effectively describing particular embodiments only and are not intended to limit the present invention.

In the present invention, hydrophobicity means that the membrane is not wetted with water or an aqueous solution. More specifically, in the present invention, hydrophobicity means that a water contact angle is more than 90 degrees, more preferably, the water contact angle is 100 degrees or more, and specifically 100 to 150 degrees.

The present invention is characterized by interfacial polymerization of the polyolefin-based microporous membrane having hydrophobicity without a separate hydrophilization treatment.

According to an embodiment of the present invention, it is characterized by replacing a conventional porous support in the form of fabric or nonwoven fabric with a polyolefin-based microporous membrane in the form of a film or a sheet. The sheet form means a microporous membrane produced by melt extrusion or casting a polyolefin-based resin. The film form means a microporous membrane produced by casting and stretching a polyolefin-based resin or by melt extruding and stretching a composition including a polyolefin-based resin and a diluent. In other words, the polyolefin-based microporous membrane of the present invention may include all polyolefin-based microporous membranes produced by a dry method or a wet method.

The present inventors thought that a microporous membrane having pores formed by cracking between phase separation or intercrystal interfaces by using a polyolefinic semi-crystalline polymer as a raw material and securing strength through a stretching process was capable of forming a polyamide active layer and supporting a reverse osmosis operating pressure within a specific pore structure and physical property ranges, and completed the present invention.

In addition, as a result of conducting studies on an interfacial polymerization of the polyolefin-based microporous membrane having hydrophobicity without a separate hydrophilization treatment, the present inventors found that a polyamide active layer was formed on a hydrophobic polyolefin-based microporous membrane by interfacial polymerization in which the polyfunctional acyl halide organic solution was first contacted and then the polyfunctional amine aqueous solution was contacted on the contrary to the conventional interfacial polymerization method in which a polyfunctional amine aqueous solution is first contacted and then a polyfunctional acyl halide organic solution is contacted, and completed the present invention.

In an embodiment of the present invention, the polyolefin-based microporous membrane means a microporous membrane produced by mixing a polyolefin-based resin and a diluent, melt extrusion, stretching, and extraction of the diluent.

In an embodiment of the present invention, the polyolefin-based microporous membrane may have a water contact angle of more than 90 degrees, more specifically, a water contact angle of 91 to 150 degrees, and more preferably 100 to 150 degrees.

In an embodiment of the present invention, the polyolefin-based resin forming the polyolefin-based microporous membrane may be a homopolymer or a copolymer formed of at least one polymer selected from the group consisting of monomers including ethylene, propylene, 1-butene, 1-hexene, 1-octene, 1-pentene, 4-methyl-1-pentene, 1-hexene, 1-heptene, 1-decene, 1-undecene, 1-dodecene, norbornene, and ethylidene norbornene. The homopolymer may be polyethylene or polypropylene. More specifically, the polyethylene may be ethylene alone or a single polyethylene or a polyethylene mixture formed of combination of ethylene and an alpha olefin comonomer having 3 to 8 carbon atoms. Further, the polypropylene may be propylene alone or a single polypropylene or a propylene mixture formed of propylene and ethylene and an alpha olefin having 4 to 8 carbon atoms and having a melting temperature of 160 to 180° C. Further, in the present invention, a mixture of the polyethylene polymer and the polypropylene polymer may be used, and any polyolefin-based resin may be used without limitation.

The polyolefin-based resin is preferred to have a weight-average molecular weight of 100,000 to 1,000,000 g/mol since the polyolefin-based resin having the weight-average molecular weight within the above-described range may improve mechanical strength and durability, but the weight-average molecular weight thereof is not limited thereto.

In an embodiment of the present invention, the diluent may be an aliphatic or cyclic hydrocarbon such as nonane, decane, decalin, paraffin oil, or the like, or an organic liquid compound that is thermally stable at an extrusion processing temperature, such as a phthalic acid ester such as dibutyl phthalate, dioctyl phthalate, or the like. Paraffin oil which is harmless to the human body and has a high boiling point and low volatile component is the most preferably suitable, and more preferably, paraffin oil having a kinetic viscosity at 40° C. of 20 to 200 cSt may be used.

Here, when an amount of the polyolefin resin is 20 to 50% by weight and an amount of the diluent is 50 to 80% by weight, it is possible to produce a microporous membrane in which a kneading property between the polyolefin-based resin and the diluent is excellent, the polyolefin-based resin is not thermodynamically kneaded in the diluent, and stretchability is excellent.

Further, general additives for improving specific functions, such as an oxidation stabilizer, a UV stabilizer, an antistatic agent, an organic nucleating agent, an inorganic nucleating agent, and the like, may be further added, if necessary.

In an embodiment of the present invention, the polyolefin-based microporous membrane may be selected from:

a single-layered microporous membrane made of any one selected from polyethylene, polypropylene, and a mixture thereof;

a composite microporous membrane having two or more layers in which polyethylene and polypropylene are alternately stacked; and

a multilayer microporous membrane in which two or more layers of polyethylene or polypropylene are stacked.

In an embodiment of the present invention, the polyolefin-based microporous membrane may have a thickness of 5 to 50 μm, but the thickness thereof is not limited thereto. In the above-described range, it is possible to support a reverse osmosis operating pressure, a flow rate may increase since the membrane is a thin film, and it is easy to operate a continuous process for forming the polyamide active layer.

Further, a porosity is preferably 20 to 70%. When the porosity is within the above-described range, the permeate flow rate is excellent, strength of the support is excellent, and the permeate flow rate is improved. Further, the maximum pore size measured by the bubble point method is preferably 0.1 μm or less, and more preferably 10 to 100 nm. Since density of the polyamide active layer is not lowered within the above-described range of the pore size, the salt rejection may be excellent, and an effect of increasing the permeate flow rate may be exhibited. Further, in order to support the reverse osmosis operating pressure, a multiplication of thickness and tensile strength in at least one of a longitudinal direction and a transverse direction is preferably 0.3 kgf/cm or more, and more specifically, 0.3 to 10 kgf/cm.

According to an embodiment of the present invention, the polyamide active layer may be formed by interfacial polymerization of the polyfunctional amine-containing aqueous solution and the polyfunctional acyl halide-containing organic solution. Further, the interfacial polymerization is characterized by the contact order, and the present invention is characterized by first contacting the polyolefin-based microporous membrane with the polyfunctional acyl halide-containing organic solution, and then contacting the polyolefin-based microporous membrane with the polyfunctional amine-containing aqueous solution. The contacting may be coating or immersion, but is not limited thereto.

The polyfunctional acyl halide-containing organic solution is obtained by dissolving a polyfunctional acyl halide compound in an aliphatic hydrocarbon-based organic solution, wherein the polyfunctional acyl halide compound is an aromatic compound having 2 to 3 carboxylic acid halides, and examples of the polyfunctional acyl halide compound may include, without limitation, trimesoyl chloride, isophthaloyl chloride, terephthaloyl chloride, or a mixture thereof, but the polyfunctional acyl halide compound is not limited thereto. The polyfunctional acyl halide compound may have an amount of 0.01 to 5% by weight in the organic solution.

Further, the aliphatic hydrocarbon-based organic solution may be a hydrophobic liquid which is not mixed with water, such as halogenated hydrocarbons, i.e., freons and alkanes having 6 to 12 carbon atoms, and more specifically, the aliphatic hydrocarbon-based organic solution may be, for example, n-hexane, cyclohexane, heptane, benzene, toluene, dioxane, or the like, but is not limited thereto.

The polyfunctional amine-containing aqueous solution is obtained by dissolving a polyfunctional amine in water. The polyfunctional amine compound may be at least one polyfunctional amine such as an aromatic polyfunctional amine substituted or unsubstituted with an alkyl group having 1 to 6 carbon atoms, or an alkoxy group having 1 to 6 carbon atoms, a hydroxyalkyl group, a hydroxyl group, or a halogen atom, or the like, or benzidine, diaminobenzidine or a benzidine derivative substituted with an alkyl or a halogen atom, or the like, and naphthalene diamine. More specific examples of the polyfunctional amine may include o-phenylenediamine, m-phenylenediamine, p-phenylenediamine, 1,3,5-benzenetriamine, 4-chloro-1,3-phenylenediamine, 5-chloro-1,3-phenylenediamine, 3-chloro-1,4-phenylenediamine; aromatic polyfunctional amines substituted with an alkyl group such as a methyl group or an ethyl group, an alkoxy group such as a methoxy group or an ethoxy group, an hydroxyalkyl group, a hydroxyl group, a halogen atom, or the like, or a derivative thereof; benzidine, diaminobenzidine; or a benzidine derivative substituted with an alkyl or a halogen atom, or the like, or naphthalene diamine, or the like, but the examples thereof are not necessarily limited thereto. Among them, m-phenylenediamine, p-phenylenediamine, 1,3,6-benzenetriamine, 4-chloro-1,3-phenylenediamine, 6-chloro-1,3-phenylenediamine, 3-chloro-1,4-phenylenediamine or a mixture thereof is preferably used, and m-phenylenediamine is the most preferably used. The polyfunctional amine compound may have an amount of 0.1 to 20% by weight, and more preferably 1.0 to 10% by weight in the aqueous solution.

The reverse osmosis membrane of the present invention may satisfy physical properties in which a salt rejection is 90% or more and a permeate flow rate is 20 L/m²hr or more.

Hereinafter, a production method for a reverse osmosis membrane of the present invention is described in detail.

<Step of Producing a Polyolefin-Based Microporous Membrane in the Form of a Film>

In an embodiment of the present invention, a production method for a polyolefin-based microporous membrane by a wet method in the production method for a reverse osmosis membrane is described in more detail, the method including:

(a) preparing a melt by injecting a polyolefin-based resin (component 1) and a diluent (component 2), which is capable of achieving liquid-liquid phase separation with the polyolefin resin, into an extruder, followed by kneading and extruding;

(b) passing the melt through a section where an extrusion temperature is below a liquid-liquid phase separation temperature to perform the liquid-liquid phase separation, thereby producing the melt into the form of a sheet;

(c) stretching the sheet; and

(d) extracting the diluent (component 2) from the sheet and drying the sheet.

Further, a production method for a polyolefin-based microporous membrane by a dry method may be performed by melt-extruding the polyolefin-based resin, followed by casting or blowing, and then stretching.

More specifically, the production method for a polyolefin-based microporous membrane is described in Korean Patent Nos. 10-0943697, 10-0943234, 10-0943235, 10-0943236, 10-1199826, 10-1288803, 10-1432146, 10-1437852, 10-1269203, 10-1404451, 10-1394622, 10-1404461, 10-0976121, 10-1004580, 10-1269207, 10-1394624, and the like, but is not limited thereto.

<Step of Surface Interfacial Polymerization>

In the interfacial polymerization, the present invention is characterized by contacting the polyolefin-based microporous membrane, which is hydrophobic, with an aliphatic hydrocarbon-based organic solution in which the polyfunctional acyl halide is dissolved, and then contacting the polyolefin-based microporous membrane with a polyfunctional amine aqueous solution. When the polyolefin-based microporous membrane which is hydrophobic is first in contact with the polyfunctional amine aqueous solution, the polyfunctional amine aqueous solution does not permeate into the microporous membrane, and thus the polyamide active layer is not able to be stably formed. Thus, in the present invention, the polyamide active layer may be stably formed by first contacting the surface of the polyolefin-based microporous membrane which is hydrophobic with the aliphatic hydrocarbon-based organic solution in which a polyfunctional acyl halide is dissolved, the polyfunctional acyl halide being capable of being sufficiently impregnated at the time of contacting the surface of the polyolefin-based microporous membrane.

In an embodiment of the present invention, the contacting may be performed by coating or immersion. The coating method may be performed by using a spray, a roller, a slot die, or the like, but is not limited thereto. More preferably, in order to smoothly perform interfacial polymerization, the contacting is preferably immersion. More specifically, the polyolefin-based microporous membrane is impregnated with the organic solution in which the polyfunctional acyl halide is dissolved for 5 seconds to 5 minutes.

Next, the impregnated polyolefin-based microporous membrane is taken out, and then the organic solution in which the excessive amount of the polyfunctional acyl halide is dissolved is removed. The removing process may be performed by compression using a rubber roll, or using a rubber blade wiper, an air knife, or the like.

Subsequently, the polyolefin-based microporous membrane is impregnated with the polyfunctional amine aqueous solution for 5 seconds to 5 minutes. Here, the polyamide is produced by a reaction of the polyfunctional amine and the polyfunctional acyl halide by the interfacial polymerization, and the polyamide active layer is formed on the surface of the polyolefin-based microporous membrane.

<Step of Removing Residual Solvent and Drying>

Finally, the polyolefin-based microporous membrane having the polyamide active layer formed thereon may be dried and then washed to obtain a polyamide reverse osmosis separation membrane. The drying and washing steps are not particularly limited, and may be performed by methods that are conventionally used in the art. Upon explaining the above description by way of an example, if drying at room temperature is capable of being performed, and the residual solvent is considered to be evaporated to some extent, the thin film is completely dried for 30 seconds to 10 minutes at 30 to 120° C., cooled to room temperature again, washed in a sodium carbonate aqueous solution at 20 to 80° C. for 30 minutes to 1 hour, and stored in pure water, thereby producing the polyamide reverse osmosis separation membrane.

Hereinafter, the present invention is described by providing Examples and Comparative Examples in more detail, but the present invention is not limited to Examples below.

Hereinafter, physical properties were measured by the following measurement methods.

1. Permeate Flow Rate (L/m²hr) and Salt Rejection (%)

The permeate flow rate and the salt rejection performance were measured in a cross-flow mode using a sodium chloride aqueous solution of 2,000 ppm at a temperature of 20° C. at a flow rate of 3.0 L/min and a reverse osmosis operating pressure of 15.5 kgf/cm². A reverse osmosis membrane cell device used for membrane evaluation was composed of a plate-type permeation cell, a high-pressure pump, a storage tank, and a cooling device, wherein an effective permeation area was 100 cm².

The flow rate of the produced water obtained is expressed as a flow rate value per unit area and unit pressure, and the salt rejection is a value indicating salt removal performance by measuring an ion conductivity (TDS) of produced water, and may be obtained by the following method:

Salt rejection (%)={1−(conductivity value of produced water/conductivity value of raw water)}×100

2. Thickness of Microporous Membrane

A TESA-μHITE product was used as a thickness meter in a contact manner in which a precision with respect to a thickness is 0.1 μm.

3. Porosity (%) of Microporous Membrane

The porosity was calculated by calculating the space inside the microporous membrane.

A sample having a width of A cm, a length of B cm, and a thickness of T cm was prepared, and the porosity was calculated by measuring a mass of the sample, and using a ratio of a resin weight and a microporous membrane weight with the same volume.

The porosity was calculated from Equation 1 below. The porosity was measured by cutting both the width of A cm and the length of B cm in the range of 5 to 20 cm, respectively.

Porosity (%)={(A×B×T)−(M/ρ)/(A×B×T)}×100 [Equation 1]

In Equation (1), T is a thickness of the sample and is expressed in the unit of cm.

M is a weight of the sample, and is expressed in the unit of g.

ρ is a density of the resin, and is expressed in the unit of g/cm³.

4. Maximum Pore Size of Microporous Membrane

The maximum pore size was measured according to ASTM F316-03 with a porometer (CFP-1500-AEL manufactured by PMI). The maximum pore size was measured by the bubble point method. A Galwick liquid (surface tension of 15.9 dyne/cm) supplied by PMI was used for pore size measurement.

5. Thickness of Microporous Membrane×Tensile Strength

Tensile strength was measured according to ASTM D882, and specifically, the tensile strength was measured at a cross-head speed of 500 mm/min using a universal testing machine (UTM).

The unit of tensile strength is kgf/cm².

Then, the thickness of the microporous membrane was conversed into the unit of cm, and the multiplication of the thickness and the tensile strength was obtained.

The multiplication of tensile strength and thickness is expressed in the unit of kgf/cm.

6. Water Contact Angle of Microporous Membrane

The water contact angle was measured by contact angle goniometry (PSA 100, KRUSS GmbH). The water contact angle was measured by dropping water droplets (3 μl)on the measurement surface with a micro-injector. Five water droplets were dropped on the surfaces of the microporous membranes produced in Examples and Comparative Examples, respectively, and the contact angle was measured with a microscope. Average values of the measured water contact angles are shown in Table 1 below.

7. Weight Average Molecular Weight

A molecular weight of a polymer was measured at 140° C. by high temperature gel permeation chromatography (GPC) from Polymer Laboratory company using 1,2,4-trichlorobenzene (TCB) as a solvent, and a standard sample for measuring the molecular weight was polystyrene.

### EXAMPLE 1

1) Production of Microporous Membrane

35% by weight of high density polyethylene having a weight average molecular weight of 3.8×10⁵ g/mole was mixed with 65 weight % of diluent in which dibutyl phthalate is mixed with paraffin oil having a kinetic viscosity at 40° C. of 160 cSt at a weight ratio of 1:1 weight ratio. The composition was extruded at 245° C. using a biaxial compounder equipped with a T-die, passed through a section set at 175° C. to induce phase separation of polyethylene and diluent present in a single phase, thereby producing a sheet using a casting roll. The sheet manufactured by using the continuous biaxial stretching machine was stretched 7.0 times at a stretching temperature of 127° C. in longitudinal and transverse directions, respectively, a heat fixing temperature after stretching was 130° C., the sheet was manufactured with a heat fixing width 1 time in a preheating section, 1.3 times in a heat stretching section, and 1.2 times in a final heat setting section. Physical properties of the produced polyethylene microporous membrane were measured and are shown in Table 1 below.

2) Manufacture of Reverse Osmosis Membrane

A 0.15% by weight of TMC organic solution was prepared by dissolving trimethoyl chloride (TMC, 98%) in n-hexane (98%).

A 3% by weight of m-phenylenediamine (MPD) aqueous solution was prepared by dissolving MPD (99%) in deionized water (Milli-Q water, 18 MΩ·cm).

The polyethylene microporous membrane produced above was impregnated into the TMC organic solution for 30 seconds and taken out, and the residual solvent was removed using a rubber roller.

The reverse osmosis membrane support from which the residual solvent was removed was impregnated with the MPD aqueous solution for 1 minute, taken out, washed with n-hexane, and dried at room temperature for 5 minutes.

The dried product was washed with an aqueous solution including 0.2% by weight of sodium carbonate for 30 minutes, and further washed with pure water at room temperature to produce a reverse osmosis membrane.

Physical properties of the produced reverse osmosis membrane were evaluated and shown in Table 1 below.

### EXAMPLES 2 TO 6

As shown in Table 1 below, the polyolefin microporous membranes were produced in the same manner as in Example 1, except that production conditions, that is, the thickness, porosity, maximum pore size, multiplication of tensile strength and thickness, and water contact angle were changed.

Physical properties of the produced polyolefin microporous membranes and the produced reverse osmosis membranes were evaluated and shown in Table 1 below.

### EXAMPLE 7

A casting film made of homopolypropylene having a melt flow index of 2.0 g/10 min at 230° C. was heat-treated, and then subjected to 10% stretching at 50° C. in an uniaxial direction and 150% stretching at 130° C. to produce a polypropylene microporous membrane.

The produced polypropylene microporous membrane was subjected to interfacial polymerization by the same method as in Example 1 to produce a reverse osmosis membrane.

Physical properties of the produced polypropylene microporous membrane and the produced reverse osmosis membrane were evaluated and shown in Table 1 below.

### COMPARATIVE EXAMPLE 1

A reverse osmosis membrane was produced by using the same microporous membrane, MPD aqueous solution, and TMC organic solution as in Example 1.

Here, the produced polyethylene microporous membrane was impregnated with the MPD aqueous solution without hydrophilization treatment for 1 minute and taken out, and the residual solution was removed using a rubber roller. Then, the polyethylene microporous membrane was impregnated with the TMC organic solution for 1 minute, taken out, washed out with n-hexane, and dried at room temperature for 5 minutes.

The dried product was washed with an aqueous solution including 0.2% by weight of sodium carbonate for 30 minutes, and further washed with pure water at room temperature to produce a reverse osmosis membrane.

Physical properties of the produced reverse osmosis membrane were evaluated and shown in Table 1 below.

### COMPARATIVE EXAMPLE 2

A reverse osmosis membrane was produced by using the MPD aqueous solution and TMC organic solution without hydrophilization treatment using the same microporous membrane as in Example 3.

Here, the produced polyethylene microporous membrane was impregnated with the MPD aqueous solution for 1 minute and taken out, and the residual solution was removed using a rubber roller. Then, the polyethylene microporous membrane was impregnated with the TMC organic solution for 1 minute, taken out, washed out with n-hexane, and dried at room temperature for 5 minutes.

The dried product was washed with an aqueous solution including 0.2% by weight of sodium carbonate for 30 minutes, and further washed with pure water at room temperature to produce a reverse osmosis membrane.

Physical properties of the produced reverse osmosis membrane were evaluated and shown in Table 1 below.

TABLE 1

| | | Characteristics of polyolefin microporous membrane | | | | | | |
|---|---|---|---|---|---|---|---|---|
| | | | | Thickness × tensile | | Water | | |
| | | Frictional | Maximum | strength (kgf/cm) | | contact | Salt | Permeate |
| | Thickness | void | pore size | Longitudinal | Transverse | angle | rejection | flow rate |
| | (μm) | (%) | (nm) | direction | direction | (°) | (%) | (L/m²hr) |
| Example 1 | 20 | 46 | 50 | 3.9 | 3.5 | 120 | 92 | 24 |
| Example 2 | 20 | 46 | 50 | 3.9 | 3.5 | 119 | 93 | 22 |
| Example 3 | 20 | 62 | 74 | 3.2 | 1.5 | 125 | 94 | 21 |
| Example 4 | 30 | 70 | 88 | 2.4 | 1.5 | 120 | 91 | 26 |
| Example 5 | 5 | 21 | 28 | 1.5 | 1.2 | 120 | 93 | 25 |
| Example 6 | 25 | 66 | 99 | 2.6 | 1.0 | 125 | 91 | 22 |
| Example 7 | 25 | 39 | 51 | 5.5 | 0.3 | 119 | 95 | 23 |
| Comparative | 20 | 46 | 50 | 3.9 | 3.5 | 120 | 7.0 | 13.8 |
| Example 1 | | | | | | | | |
| Comparative | 20 | 62 | 74 | 3.2 | 1.5 | 119 | 26.3 | 0.7 |
| Example 2 | | | | | | | | |

As shown in Table 1, it could be appreciated that in Examples 1 to 7, the polyamide active layers were stably formed by using the hydrophilic polyolefin microporous membranes even without a separate hydrophilization treatment, and physical properties of the salt rejection and the permeate flow rate were excellent.

As shown in Comparative Examples 1 and 2, it could be appreciated that when the polyfunctional amine aqueous solution was first contacted during the interfacial polymerization, the salt rejection and the permeate flow rate were relatively lowered even when the microporous membranes having the same physical properties were used.

1. A production method for a reverse osmosis membrane comprising:
contacting a polyolefin-based microporous membrane with a polyfunctional acyl halide organic solution, and then contacting the polyolefin-based microporous membrane with a polyfunctional amine aqueous solution to form a polyamide active layer.

2. The production method of claim 1, wherein the polyolefin-based microporous membrane has a water contact angle of more than 90 degrees.

3. The production method of claim 1, wherein the contacting is coating or immersion.

4. The production method of claim 1, wherein the polyolefin-based microporous membrane has a porosity of 20 to 70%, a maximum pore size measured by a bubble point method of 0.1 μm or less, and a multiplication of tensile strength and thickness in at least one of a transverse direction and a longitudinal direction is 0.3 kgf/cm or more.

5. The production method of claim 1, wherein the polyolefin-based microporous membrane is a film or a sheet.

6. The production method of claim 1, wherein the polyolefin-based microporous membrane is selected from:
a single-layered microporous membrane made of any one selected from polyethylene, polypropylene, and a mixture thereof;
a composite microporous membrane having two or more layers in which polyethylene and polypropylene are alternately stacked; and
a multilayer microporous membrane in which two or more layers of polyethylene or polypropylene are stacked.

7. The production method of claim 1, wherein the polyfunctional acyl halide organic solution is obtained by dissolving a polyfunctional acyl halide compound in an aliphatic hydrocarbon-based organic solution, and the polyfunctional amine aqueous solution is obtained by dissolving a polyfunctional amine in water.

8. A reverse osmosis membrane comprising:
a polyamide active layer formed on a polyolefin-based microporous membrane,
wherein the polyolefin-based microporous membrane has a water contact angle of more than 90 degrees.

9. The reverse osmosis membrane of claim 8, wherein the polyolefin-based microporous membrane has a porosity of 20 to 70%, a maximum pore size measured by a bubble point method of 0.1 μm or less, and a multiplication of tensile strength and thickness in at least one of a transverse direction and a longitudinal direction is 0.3 kgf/cm or more.

10. The reverse osmosis membrane of claim 8, wherein the polyolefin-based microporous membrane is selected from:
a single-layered microporous membrane made of any one selected from polyethylene, polypropylene, and a mixture thereof;
a composite microporous membrane having two or more layers in which polyethylene and polypropylene are alternately stacked; and
a multilayer microporous membrane in which two or more layers of polyethylene or polypropylene are stacked.
